(19) United States
(12) Patent Application Publication
(10) Pub. No.: US 2009/0051921 A1
(43) Pub. Date: Feb. 26, 2009

(54) OPTICAL SENSOR

(76) Inventor: Tsumori MASAHIKO, Suwon-si (KR)

Correspondence Address: CHA & REITER, LLC, 210 ROUTE 4 EAST STE 103, PARAMUS, NJ, 07652, US

(21) Appl. No.: 12/193,974

(22) Filed: Aug. 19, 2008

(30) Foreign Application Priority Data
Aug. 20, 2007 (KR) P2007-0083675

(51) Int. Cl. G01B 9/02; G01N 21/55; G01B 11/14

(52) U.S. Cl. 356/450; 356/445; 356/614

(57) ABSTRACT

An optical sensor includes an optical detector for detecting light reflected from an object to be sensed, an optical source for producing light for illuminating the object to be sensed, and a reflection unit for reflecting the light reflected from the object to be sensed toward the optical detector, the reflection unit being positioned on the path of the light reflected from the object to be sensed, such that the interference of light between the light source and the optical detector is minimized.

### CLAIM OF PRIORITY

This application claims the benefit under 35 U.S.C. §119(a) of an application entitled “Optical Sensor” filed in the Korean Intellectual Property Office on Aug. 20, 2007 and assigned Serial No. 2007-83675, the contents of which are hereby incorporated by reference.

### BACKGROUND OF THE INVENTION

1. Field of the Invention

The present invention relates to a sensor, and in particular to an optical sensor.

2. Description of the Related Art

A sensor is utilized to detect various forms of physical quantities, such as sound, light, temperature, pressure, etc. In particular, optical sensors are employed for sensing and measuring various objects, such as a position of an object, a human body, etc., using light.

FIG. 1 illustrates a conventional optical sensor, and FIG. 2 is a cross-section of the optical sensor so as to show a distance relation between an optical source and an optical detector shown in FIG. 1. As shown, the conventional optical sensor 100 includes an optical source 120, an optical detector 130 for measuring light returned from an object to be sensed, a first lens 141 for collimating light produced from the optical source 120, and a second lens 142 for rendering light reflected from the object to be convergent on the optical detector 130. The optical sensor 100 may be integrated on a printed circuit board 110 or the like.

The optical sensor 100 is intended to calculate physical quantities (such as distance, size, displacement, etc.) by illuminating light on an object to be sensed or a physical solid, then measuring light reflected by and returned from the object or the physical solid, wherein the intensity of light reflected and returned from the projected light and the length of time required for returning are used for measurement. Therefore, it is necessary for the optical sensor 100 to suppress or minimize interference between the projected light and the light reflected from the object to be sensed to achieve an accurate measurement.

Referring to FIG. 2, L indicates a distance between the first lens 141 and the object to be sensed, D indicates a distance between the optical source 120 and a normal line (one-point chain line) perpendicular to the incident plane of the second lens 142, and d1 indicates a distance between the normal line (one-point chain line) and a light-incident point of the optical detector 130. If the distance between the optical source 120 and the optical detector 130 is reduced, the projected light and the incident light may interfere with each other.

As such, an optical sensor requires an optimal-spacing between an optical source and an optical detector so as to minimize interference between lights inputted or outputted from a precise lens system, the optical source, and the optical detector. This renders the volume of the optical sensor to be increased which is undesirable in miniaturization efforts for portable wireless terminals.

### SUMMARY OF THE INVENTION

Accordingly, the present invention has been made to solve the above-mentioned problems occurring in the prior art and provides additional advantages, by providing an optical sensor capable of realizing a high optical resolution and realized in a smaller size than prior arts.

According to an aspect of the present invention, an optical sensor includes: an optical source for producing light, an optical detector for detecting light reflected from an object to be sensed, and a reflection unit for reflecting the light reflected from the object to be sensed toward the optical detector.

### BRIEF DESCRIPTION OF THE DRAWINGS

The above features and advantages of the present invention will be more apparent from the following detailed description taken in conjunction with the accompanying drawings, in which:

FIG. 1 shows a conventional optical sensor;

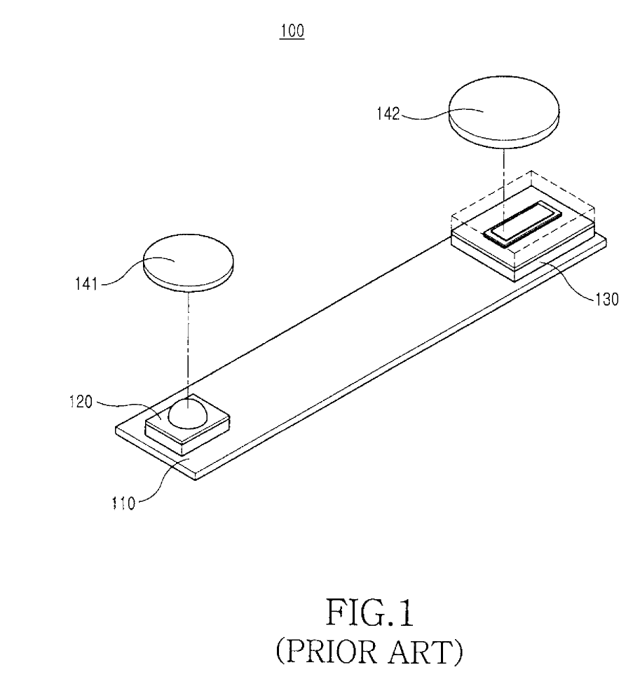

FIG. 2 shows a cross-section of the optical sensor of FIG. 1;

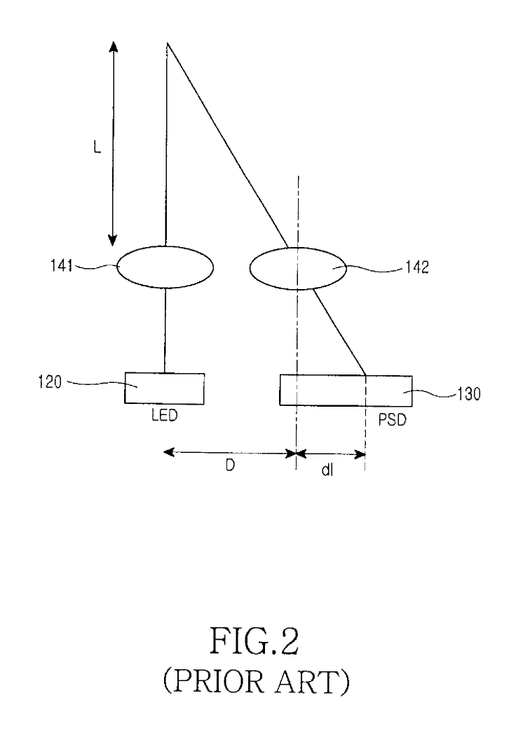

FIG. 3 shows an optical sensor according to an embodiment of the present invention; and

FIG. 4 shows a cross-section of the optical sensor of FIG. 3.

### DETAILED DESCRIPTION OF THE INVENTION

Hereinafter, an embodiment of the present invention will be described with reference to the accompanying drawings. It should be noted that in the following description, the same elements will be designated by the same reference numerals even though they are shown in different drawings. For the purposes of clarity and simplicity, a detailed description of known functions and configurations incorporated herein will be omitted as it may make the subject matter of the present invention unclear.

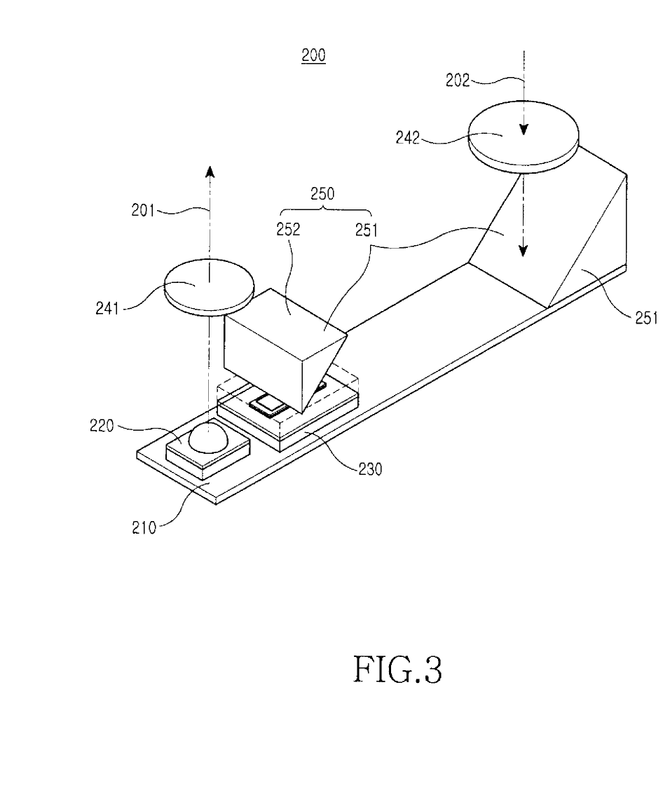

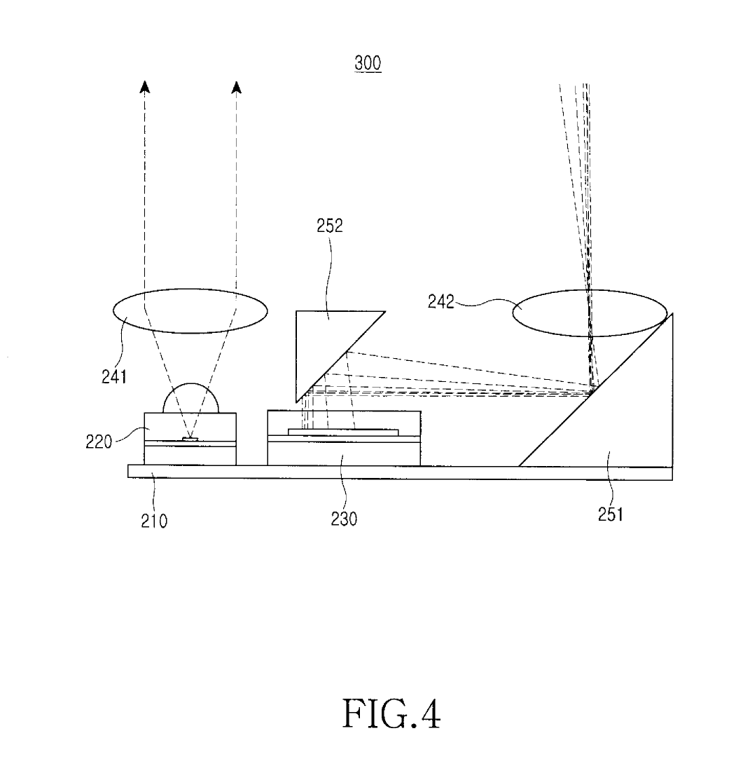

FIG. 3 shows an optical sensor according to an embodiment of the present invention; and FIG. 4 shows a cross-section of the optical sensor of FIG. 3.

Referring to FIGS. 3 and 4, the inventive optical sensor 200 includes an optical detector 230 for detecting light reflected from an object to be sensed, an optical source 220 for producing light for illuminating the object to be sensed, a reflection unit 251 for reflecting the light reflected from the object to be sensed toward the optical detector 230, the reflection unit being positioned on the path of the light reflected from the object to be sensed, and first and second lens systems 241 and 242, wherein the optical source 220, the optical detector 230, etc. can be integrated on a printed circuit board 210.

The optical sensor 200 according to the present embodiment is adapted to change, at the reflection unit 250, the path of light reflected from the object to be sensed. As a result, the optical sensor 200 can be applied in various forms at a limited space while minimizing the interference of light between the light source 220 and the optical detector 230.

The first lens system 241 is positioned between the light source 220 and the object to be sensed, collimates the light 201 produced at the light source 220, and projects the light 201 toward the object to be sensed. The second lens system 242 is positioned between the object to be sensed and the reflection unit 250 so as to converge the light 202 reflected from the object to be sensed on the reflection unit 250.

The reflection unit 250 includes a first reflection member 251 for reflecting the light 201 reflected from the object to be sensed, and a second reflection member 252 for reflecting the light reflected from the first reflection member 251 to the optical detector 230.

Each of the first and second reflection members 251 and 252 may include a prism with a reflection surface or a reflection mirror. In particular, an integrated polyhedral-shaped prism may be employed for the reflection members 251 and 252.

An IR LED (InfraRed Light Emitting Diode) may be employed for the light source 220, and a PSD (Position Sensitive Detector) may be employed for the light detector 230. In particular, an optical interferometer may be employed for the optical detector 230 so as to measure light intensity, and a length of time required for the reflected light to return to the light source, depending on the physical quantities desired to measure. The optical interferometer may be positioned between the first reflection member 251 and the light source 220.

According to the teachings of the present invention, the volume of an optical sensor can be minimized because a reflection member, such as a prism or a reflection member, is positioned on the path of the light reflected from an object to be sensed so that the light reflected from the object to be sensed is reflected toward the optical sensor.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical sensor comprising:
an optical detector for detecting light reflected from an object to be sensed;
an optical source for producing light for illuminating the object to be sensed; and
a reflection unit for reflecting the light reflected from the object to be sensed toward the optical detector, the reflection unit being positioned on the path of the light reflected from the object to be sensed.

2. The optical sensor as claimed in claim 1, further comprising:
a first lens system for collimating and projecting light produced from the light source toward the object to be sensed, the first lens system being disposed between the light source and the object to be sensed; and
a second lens system for converging the light reflected from the object to be sensed on the reflection unit, the second sense system being disposed between the object to be sensed and the reflection unit.

3. The optical sensor as claimed in claim 1, wherein the reflection unit comprises:
a first reflection member for reflecting the light reflected from the object to be sensed; and
a second reflection member for reflecting the light reflected by the first reflection member toward the optical detector.

4. The optical sensor as claimed in claim 1, wherein the light source comprises an IR LED (InfraRed light Emitting Diode).

5. The optical sensor as claimed in claim 1, wherein the optical sensor comprises a position detector.

6. The optical sensor as claimed in claim 3, wherein the first and second reflection members comprises a prism having a reflection surface or a reflection mirror.

7. The optical sensor as claimed in claim 1, wherein the optical detector is disposed between the light source and the reflection unit.

8. The optical sensor as claimed in claim 7, wherein the reflection unit comprises a polyhedral-shaped prism.

9. The optical sensor as claimed in claim 1, wherein the optical detector comprises an optical interferometer.

10. An optical sensor for sensing an object, comprising:
an optical source for generating light to illuminate the object;
an optical detector for detecting light reflected from the object;
a first lens, disposed between the light source and the object, for collimating and projecting light produced from the light source toward the object;
a first reflection unit at one end and disposed above the optical detector and a second reflection unit at the other end; and
a second lens, disposed between the object and the second reflection unit, for converging the light reflected from the object on the second reflection unit.

11. The optical sensor as claimed in claim 10, wherein the light source comprises an IR LED (InfraRed Light Emitting Diode).

12. The optical sensor as claimed in claim 10, wherein the optical sensor comprises a position detector.

13. The optical sensor as claimed in claim 10, wherein the first and second reflection units comprises a prism with having a reflection surface or a reflection mirror.

14. The optical sensor as claimed in claim 10, wherein the first and the second reflection units comprises a polyhedral-shaped prism.

15. The optical sensor as claimed in claim 10, wherein the optical detector comprises an optical interferometer.
